(19) United States
(12) Patent Application Publication
(10) Pub. No.: US 2007/0262584 A1
(43) Pub. Date: Nov. 15, 2007

(54) Energy recovery system for moving vehicle

(76) Inventor: Min-Der Lu, Russellville, AR (US)

Correspondence Address: WRIGHT, LINDSEY & JENNINGS LLP, 200 WEST CAPITOL AVENUE, SUITE 2300, LITTLE ROCK, AR, 72201-3699, US

(21) Appl. No.: 11/430,420

(22) Filed: May 9, 2006

(51) Int. Cl. F03D 9/00

(52) U.S. Cl. 290/55

(57) ABSTRACT

A system to recover energy from the air stream associated with a moving vehicle has a turbine disposed within the air stream and operatively connected through a drive shaft to an electrical generator. The turbine has a plurality of vanes characterized by a pitch angle which is controllable so that when braking or decelerating the vanes are pitched at an angle to the air stream to assist in slowing the vehicle by increasing the drag of the wind on the vehicle and in generating electricity through the rotation of the turbine. A controller determines the pitch of the vanes based on the operating conditions of the vehicle and the actions of the user. The electrical generator may be provided with a plurality of rotors, each with its associated electrical coil. Each rotor is operatively connected to the drive shaft from the turbine by means of a releasable pin. One or any number of rotors up to the full complement may be selected to be connected to the drive shaft at any time. Rotors that are not connected by the pin to the drive shaft are free wheeling and do not provide any addition to the generation of electricity. Rotors that are connected by their associated pins to the drive shaft are rotated by the turbine and assist in generating electricity. To avoid overheating of the generator, all the rotors may be made free wheeling. Likewise, the turbine may be connected to the drive shaft by a releasable pin.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates to an energy recovery system for a moving vehicle, and in particular, to such a system which is controllable to maximize the energy recovery based on vehicle operation conditions and operator actions.

2. Brief Description of the Related Art

Various patents are related to the concept of mounting a fan or turbine on a vehicle to generate electricity when the vehicle is moving. For example, U.S. Pat. No. 5,287,004 to Finley discloses a horizontally mounted turbine at the rear of the vehicle. The passage of air over the vehicle turns the turbine and generates electricity.

Other patents disclose devices that combine electricity generation and aerodynamic braking. For example, U.S. Pat. No. 3,556,239 to Spahn discloses an automobile with air scoops feeding air to an internal air turbine to generate electricity. A front air scoop has doors that can be opened to increase the drag. In addition, the electrical generator is stated to produce some braking force when it is operating.

U.S. Pat. No. 4,632,205 to Lewis also discloses a combined generator and brake system for an automobile. An electricity generator is driven by air pressure when the car is moving and also when the car is at rest so long as sufficient wind is blowing. When braking is desired, a plate is extended to oppose the movement of the vehicle and to direct air into a passageway to turn a generator.

U.S. Pat. No. 1,181,988 to Breitung discloses a windmill mounted to a boat to generate electricity. The windmill serves a dual function—when it rotates it generates electricity and when it is not rotating it can act as an additional sail to provide motive power to the boat.

### BRIEF SUMMARY OF THE INVENTION

The present invention is a system to recover energy from the air stream associated with a moving vehicle, such as an automobile, a boat, an airplane and the like, and thereby to improve the energy efficiency of the operation of the vehicle. The present invention may, for example, generate electricity and provide braking for the moving vehicle. The system comprises a turbine, a fan or the like (hereinafter referred to as a “turbine”) variably coupled to an electrical generator.

The turbine is disposed within the air stream and operatively connected through a drive shaft to an electrical generator. When accelerating or operating at a constant speed, the vanes or blades (hereinafter “vanes”) of the turbine are parallel to the wind flow and thus provide minimal drag on the vehicle. When braking or decelerating, the vanes are pitched at an angle to the wind flow to assist in slowing the vehicle by increasing the drag of the wind on the vehicle and, in addition, the system generates electricity through the rotation of the turbine.

The pitch of the vanes may be manually controlled or a mechanical or electrical device, such as a computer, may determine the pitch of the vanes based on the operating conditions of the vehicle, such as its speed, and the actions of the user. For example, when the vehicle is an automobile and the user desires to slow the vehicle, the accelerator pedal is released and/or the brake pedal is depressed. From the inputs of vehicle speed and the actions of the user with respect to the accelerator and/or the brake pedal, a computer may determine a pitch of the vanes that generates an amount of electricity to charge the battery and allow safe slowing of the vehicle. Instead of generating electricity, the turbine may be used to provide mechanical power to operate auxiliary devices or to boost the performance of the engine.

In order to optimize the generation of electricity, in an alternative embodiment of the present invention, the electrical generator may be provided with a plurality of rotors, each with its associated electrical coil. Each rotor is operatively connected to the drive shaft from the turbine by means of a releasable pin. Thus one or any number of rotors up to the full complement may be selected to be connected to the drive shaft at any time. Rotors that are not connected by the pin to the drive shaft are free wheeling and do not provide any addition to the generation of electricity. Rotors that are connected by their associated pins to the drive shaft are rotated by the turbine and assist in generating electricity. By the same means, the turbine may be released from the drive shaft. For example, it may be desirable for the turbine to be released from the drive shaft to avoid the braking effect of the turbine, but still allow any residual momentum of the drive shaft to continue to operate the rotors.

Under some conditions, the selection of the pitch of the turbine vanes may cause the generator to operate at a level that could causes it to overheat. In such a condition, all the rotors may be made free wheeling.

These and other features, objects and advantages of the present invention will become better understood from a consideration of the following detailed description of the preferred embodiments and appended claims in conjunction with the drawings as described following:

### BRIEF DESCRIPTION OF THE SEVERAL VIEWS OF THE DRAWINGS

FIG. 1 is a side elevation view in cross section of an automobile showing the placement of a turbine of the present invention is an air stream.

FIG. 2 is a block diagram of the components of the present invention.

FIGS. 3A and 3B are front elevation and side elevation views, respectively, of the turbine of the present invention showing the vanes of the turbine pitched at a large angle to the air stream.

FIGS. 4A and 4B are analogous to FIGS. 3A and 3B with the vanes pitched at a lesser angle to the air stream.

FIGS. 5A and 5B are analogous to FIGS. 3A and 3B with the vanes pitched nearly parallel to the air stream.

FIG. 6 is a side elevation view of the turbine and generator of the present invention with the generator shown in cross section.

FIG. 7 is a cross sectional view of a detail along the line 7-7 of FIG. 6 showing the operation of a releasable pin to couple a rotor to the drive shaft.

FIG. 8 is a cross-sectional view of detail “A” of FIG. 6 showing the operation of a releasable pin to couple the turbine to the drive shaft.

### DETAILED DESCRIPTION OF THE INVENTION

With reference to FIGS. 1-7, the preferred embodiment of the present invention may be described as follows.

As shown in FIG. 1, the system of the present invention comprises a turbine 10 variably coupled to an electrical generator 11 via a drive shaft 12. The turbine 10 is disposed within the air stream (shown by arrows 13) of a moving vehicle 20. Although illustrated by an automobile in FIG. 1, the present invention is not so limited and may be used with any type of moving vehicle, including without limitation, an airplane, a boat or the like. Likewise, the electrical generator 11 may also act as a motor/generator. The term “electrical generator” as used herein is intended to include a motor/generator. The electrical generator 11 is operatively connected to a storage battery 14. In an alternative embodiment, the turbine 10 may be used directly to perform work, for example, to boost the performance of an internal combustion engine or to drive engine accessories, such as cooling fans, pumps and the like. In this alternative embodiment, the electrical generator 11 and battery 14 may or may not be employed. Alternatively, if the electrical generator 11 performs as a motor generator, the motor/generator may be connected directly to a vehicle transmission to supplement the performance of an engine.

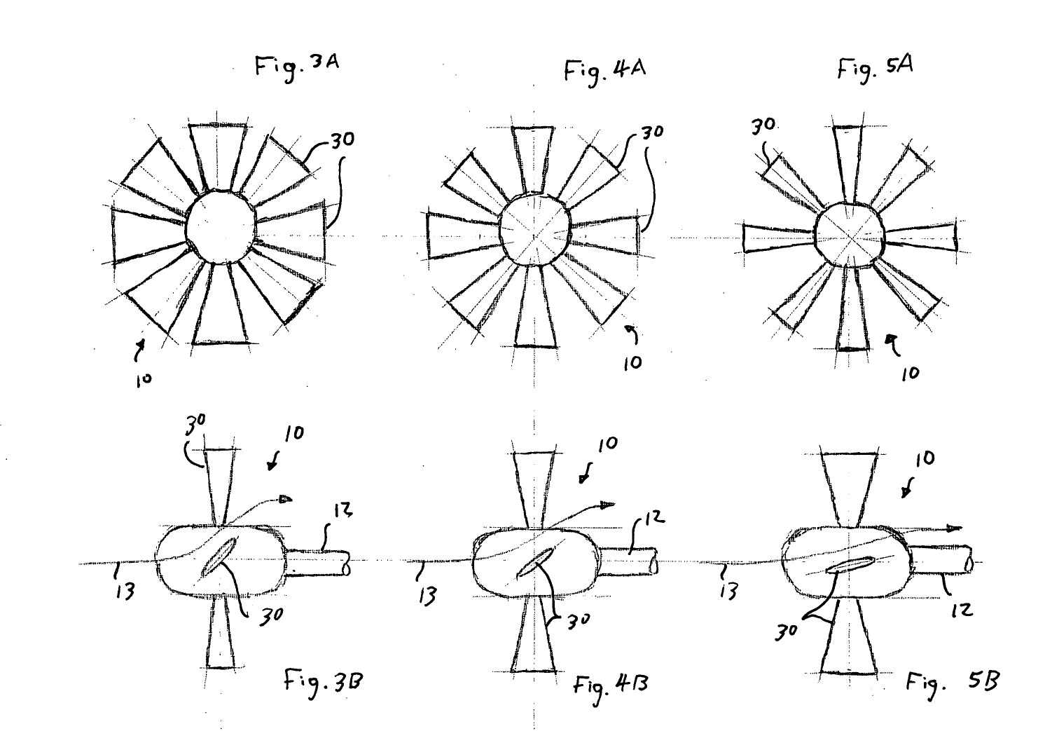

As shown in FIGS. 3A-5B, the turbine 10 has a plurality of vanes 30. Although the illustrated turbine 10 is shown with eight vanes 30, the present invention is not so limited. Any number of vanes 30 from one on up are considered to be within the scope of the present invention. Furthermore, the vanes 30 may be of the aerodynamic type or of the non-aerodynamic type. When accelerating or operating at a constant speed, the vanes 30 of the turbine 10 are parallel or nearly parallel to the wind flow 13 as shown in FIGS. 5A and 5B. Alternatively, the turbine 10 may be made free wheeling as described below. In either of these situations, the turbine 10 and vanes 30 provide minimal drag on the vehicle 20. When braking or decelerating, the vanes 30 are pitched at a steeper angle to the wind flow 13 as shown in FIGS. 4A and 4B to assist in slowing the vehicle by increasing the drag of the wind on the vehicle and, in addition, the system generates electricity or mechanical work through the rotation of the turbine 10. FIGS. 3A and 3B show an even steeper angle of the vanes 30 to the wind flow 13 to provide even more braking force and electrical generation. Any of various means to vary the pitch of vanes on a turbine are known to those skilled in the art. In the accompanying drawing figures, the turbine 10 is shown mounted vertically in the front of a vehicle and pointed toward the direction of wind flow. The present invention is not limited to this orientation. The turbine 10 may be mounted vertically or horizontally or at any angle to the horizontal or vertical as dictated by the particular application. Furthermore, the present invention is not limited to a single turbine 30, but also encompasses applications where various numbers or sizes of turbines 30 may be desirable.

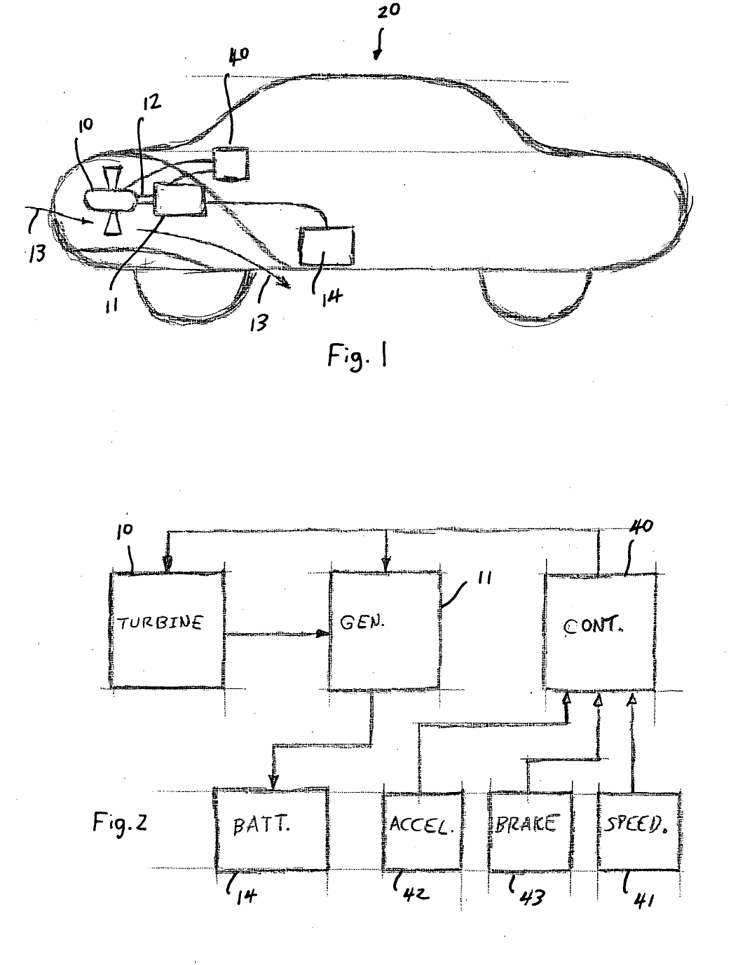

As shown in FIGS. 1 and 2, a controller 40, such as a computer, may be used to automatically determine the pitch of the vanes 30 based on the operating conditions of the vehicle 20, such as its speed as measured by speedometer 41, and the actions of the user. For example, when the vehicle 20 is an automobile and the user desires to slow the vehicle 20, the accelerator pedal 42 is released and the brake pedal 43 is depressed. From the inputs of vehicle speed and the degree of depression of the brake pedal, the controller 40 determines a pitch of the vanes 30 that generates an optimum amount of electricity and assures safe slowing of the vehicle. As used herein the term “controller” is intended to include not only a data processing device of the type commonly denominated a “computer” but may also include any device or mechanism, such as mechanical or electrical devices, that would be known to those skilled in the art as capable of controlling the operation of the various components of the present invention. The term “controller” is also intended to encompass mechanical, electrical or other means allowing a user to manually control the pitch of the vanes 30.

In order to optimize the generation of electricity, in an alternative embodiment of the present invention, the electrical generator 11 may be provided with a stator 50 and a plurality of rotors 51, each with its associated electrical coil 52. Each rotor 51 is operatively connected to the drive shaft 12 from the turbine 10 by means of a releasable rotor pin 53 controlled by the controller 40. Thus the controller 40 may select one or any number of rotors 51 up to the full complement to be connected to the drive shaft 12 at any time by moving a respective rotor pin 53 into or out of engagement with a rotor 51. Rotors 51 that are not connected by a rotor pin 53 to the drive shaft 12 are free wheeling and do not provide any addition to the generation of electricity. Rotors 51 that are connected by their associated rotor pins 53 to the drive shaft 12 are rotated by the turbine 10 and assist in generating electricity.

A releasable rotor pin 53 slides in an opening 54 in the drive shaft 12 and may be moved into and out of an opening 55 in the rotor 51 so as to engage the rotor 51 and couple it to the drive shaft 12. The rotor pin 53 may be moved into and out of engagement by any of various means that would be well known to those of skill in the art and could include, without limitation, electrical, mechanical or pneumatic means.

Under some conditions, the selection of the pitch of the turbine vanes 30 may cause the generator 11 to operate at a level that could cause it to overheat. In such a condition, the controller 40 may determine that a different pitch of the vanes is desirable or that the turbine 10 and/or some or all of the rotors 51 should be free wheeling in order to optimize the efficiency and safety of the system.

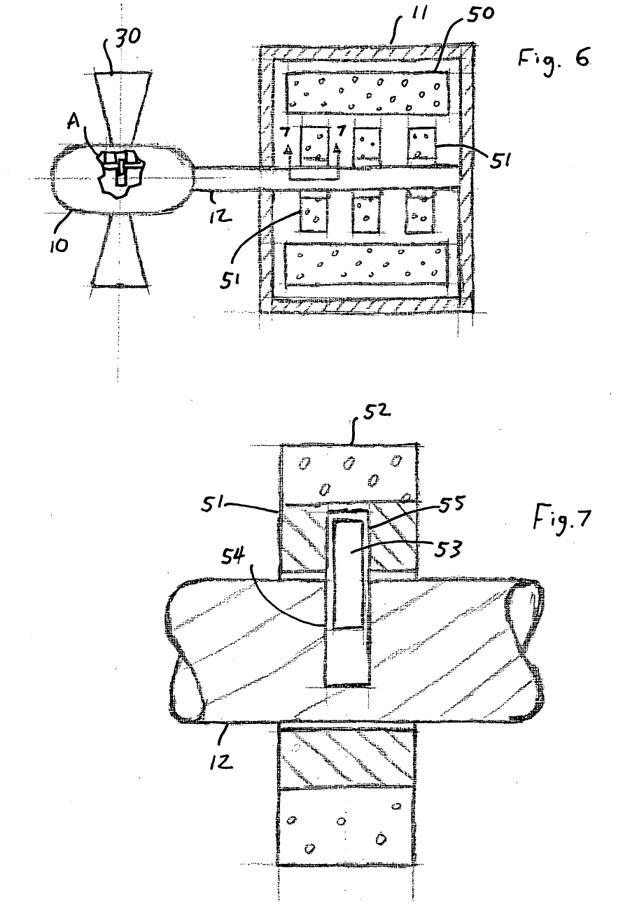

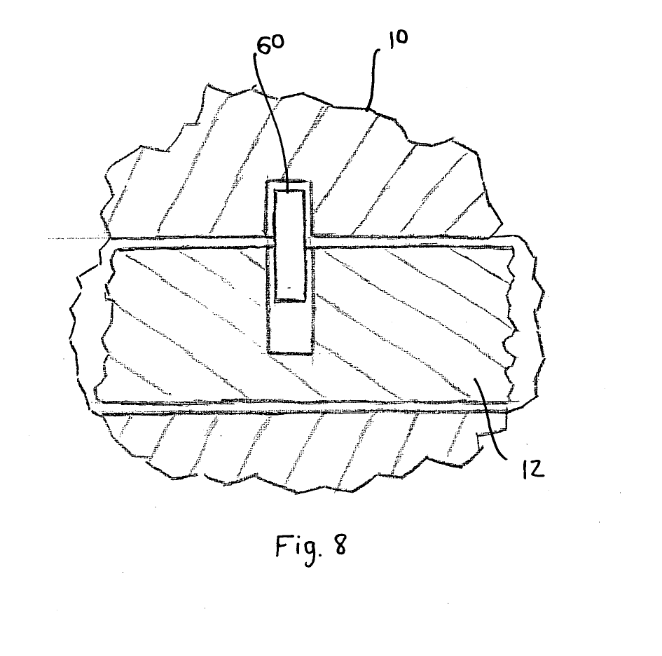

When the user decides to slow down momentarily, the accelerator pedal is released and then depressed again after a short time interval. When the accelerator pedal is released, the pitch of the vanes 30 are then immediately altered to provide a braking force and to turn the turbine 10. When the user then depresses the accelerator pedal to resume speed, there may be some residual momentum in the drive shaft 12 and the rotors 51 that would be wasted if the vanes 10 were immediately turned parallel to the wind flow. This situation is addressed in a further alternative embodiment of the present invention as shown in FIGS. 6 and 8, where the turbine 10 is releasably connected to the drive shaft 12 by a releasable turbine pin 60 as shown in detail in FIG. 8. The releasable turbine pin 60 may operate in the same manner as described above with respect to the releasable rotor pin 53. When the situation occurs as described above and the user depresses the accelerator pedal to resume speed, the releasable turbine pin 60 releases the turbine 10 from the drive shaft 12. The turbine becomes free wheeling and any residual momentum of the drive shaft 12 and rotors 51 is available to continue to generate electricity or provide mechanical work until the momentum is dissipated. This embodiment may be particularly useful when a cruise control is being employed to control the speed of a vehicle. The releasable turbine pin 60 may be controlled by the controller 40. The pitch angle of the vanes 30, the releasable rotor pins 53 and the releasable turbine pin 60 may be controlled by a single controller 40 or by separate controllers.

The present invention has been described with reference to certain preferred and alternative embodiments that are intended to be exemplary only and not limiting to the full scope of the present invention as set forth in the appended claims.

1. A system for recovering energy from an air stream associated with a moving vehicle, comprising:
a turbine disposed in the air stream, said turbine comprising a plurality of vanes characterized by a variable pitch angle;
a drive shaft operatively connected to said turbine;
an electrical generator operatively connected to said drive shaft; and
a pitch angle controller operatively connected to said vanes for determining a pitch of said vanes that generates an optimum amount of electricity and assures safe slowing of the vehicle based on the inputs of vehicle speed and the actions of the user with respect to the accelerator and brake pedal.

2. The system of claim 1, wherein said electrical generator further comprises a plurality of rotors, each of said rotors having a radially elongated opening, a radially elongated opening in said drive shaft, a releasable radially elongated rotor pin associated with each of said plurality of rotors for releasably connecting said each of said plurality of rotors to said drive shaft by moving said radially elongated rotor pin along said radially elongated opening of said rotor into and out of engagement with said radially elongated opening of said drive shaft, and a releasable rotor pin controller.

3. The system of claim 1, further comprising a releasable turbine pin associated with said turbine for releasably connecting said turbine to said drive shaft, and a releasable turbine pin controller.
